(19) United States
(12) Patent Application Publication
(10) Pub. No.: US 2008/0246709 A1
(43) Pub. Date: Oct. 9, 2008

(54) DISPLAY DEVICE

(75) Inventor: Ikuko Mori, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/060,284

(22) Filed: Apr. 1, 2008

(30) Foreign Application Priority Data
Apr. 3, 2007 (JP) 2007-097469

(51) Int. Cl. G09G 3/36

(52) U.S. Cl. 345/87

(57) ABSTRACT

A display device which includes a display panel with plural sub-pixels, first and second conversion circuits for converting the display data in the intermediate gradation input from the external system into different values, a driver which outputs the video voltage corresponding to the display data to the sub-pixels, and a second driver which scans the plural sub-pixels further includes an overdrive circuit which receives an input of identical first and second display data sequentially from the external system in two consecutive frame intervals such that the first display data are subjected to an overdrive process. The first conversion circuit converts the first display data subjected to the overdrive process in the overdrive circuit based on a frame distinction signal input from the external system, and the second conversion circuit converts the second display data based on the frame distinction signal.

### CLAIM OF PRIORITY

The present application claims priority from Japanese Application JP 2007-097469 filed on Apr. 3, 2007, the content of which is hereby incorporated by reference into this application.

### BACKGROUND OF THE INVENTION

1. Field of the Invention

The present invention relates to a display device of hold type, for example, a liquid crystal display device, an organic EL (Electro Luminescence) display, a LCOS (Liquid Crystal On Silicon) display and the like, and more particularly, to a display device suitable for displaying a video image.

2. Description of the Related Art

The display device may be classified into an impulse response type display device and a hold response type display device with respect to the video image display. With the impulse response type display device, the luminance response lowers immediately after the scan as the decay characteristic of a cathode-ray tube. With the hold response type display device, the luminance based on the display data may be held until the next scan like the liquid crystal display device.

The hold response type display device is capable of displaying the still image in good condition with no flickering, but tends to cause the motion blur, that is, the displayed area around the moving subject is blurred, resulting in markedly deteriorated display quality.

The motion blur is caused by the afterimage on the retina, that is, interpolation of the display image before/after the subject movement performed by the viewer who moves the direction of eyes to follow the moving subject with respect to the displayed image having the luminance held. So the motion blur cannot be eliminated in spite of the effort for improving the response rate of the display device as high as possible.

It is effective to update the display image at the shorter frequency, or to cancel the afterimage on the retina by inserting the black image for approximating to the impulse response type display device to solve the aforementioned problem.

The method for approximating to the impulse response type display device is disclosed in Japanese Patent Application Laid-Open Publication No. 2006-343706. With the disclosed method, the image is displayed by switching between the predetermined gradation and the minimum gradation in the case where the gradation demanded by the external system is in the low side to pseudo-display the gradation demanded by the external system (hereinafter referred to as FBI drive method).

In the FBI drive method, the respective sub-pixels display the plural gradations so as to pseudo-display the gradation demanded by the external system. When the gradation demanded by the external system is in the intermediate low level, at least one of the plural gradations is set to the minimum gradation (minimum luminance). When the gradation demanded by the external system is in the intermediate high level, at least one of the other plural gradations is set to the maximum gradation (maximum luminance).

Specifically, when the gradation demanded by the external system is in the low side, the predetermined gradation is switched to the minimum gradation for performing the pseudo-display of the gradation demanded by the external system.

Meanwhile, when the gradation demanded by the external system is in the high side, the predetermined gradation is switched to the maximum gradation for performing the pseudo-display of the gradation demanded by the external system.

FIG. 6 represents the conventional FBI drive method, showing the state where the gray subject has moved toward the arrow A direction. In FIG. 6, each code of FMD and FRD denotes the luminance of the sub-pixel on the single display line in the single frame, and the arrow with dashed line denotes the time passage.

Referring to FIG. 6A, a liquid crystal display module receives an input of the display data at 60 Hz frame from outside so as to be stored in the frame memory. The 60 Hz frame display data stored in the frame memory are read twice in the single frame to generate two display data twice as high as 60 Hz frame, that is, 120 Hz frame.

Referring to FIG. 6C, an overdrive (OD) process is performed. FIG. 6 shows the sub-pixel corresponding to the display data subjected to the overdrive process with the bold line frame.

Referring to FIG. 6D, the first display data at 120 Hz frame are converted into those for the bright frame, and the next display data at 120 Hz frame are converted into those for the dark frame through the FBI processing.

The aforementioned process improves the video image quality by performing the impulse drive in the low gradation with the black insertion by 50%. In this case, the OD factor is set to 0 for the dark frame such that the overdrive process is performed only to the bright frame for the purpose of improving the video image quality.

Generally, the frame memory is required for increasing the frequency of the display data at the input 60 Hz frame by twice. However, it is effective to eliminate the frame memory as one of processes for reducing the cost.

In order to eliminate the frame memory, two identical display data have to be externally input for the respective consecutive frames at 120 Hz twice as high as 60 Hz.

When it is assumed that the display data in the first and the second frames sequentially are set to the first and the second display data, respectively, those first and the second display data cannot be distinguished in the liquid crystal display module. Two kinds of drive methods are then performed in the FBI process, that is, the display data subjected to the overdrive process are converted into those for the bright frame or the dark frame.

However, the display data subjected to the overdrive process are required to be set to those for the bright frame in view of performance of the video image.

### SUMMARY OF THE INVENTION

It is an object of the present invention to provide a display device to which the identical display data are externally input twice for improving the video performance by distinguishing the number of the order for inputting the display data.

The above and other related objects and features of the present invention will be apparent from a reading of the following description of the disclosure found in the accompanying drawings.

The representative features of the present invention will be described as follows.

(1) A display device is provided with a display panel including plural sub-pixels, a first conversion circuit and a second conversion circuit each for converting display data in an intermediate gradation input from an external system into different values, a signal generation circuit for generating a control signal for driving the display panel based on a signal input from the external system, a driver for outputting an image voltage corresponding to the display data to the plural sub-pixels. The display device which receives two identical data of first and second display data sequentially from the external system in a two consecutive frame intervals further includes an overdrive circuit for subjecting the first display data to an overdrive process. The first conversion circuit converts the first display data subjected to the overdrive process in the overdrive circuit based on a frame distinction signal input from the external system. The second conversion circuit converts the second display data based on the frame distinction signal. When the display data input from the external system is in the intermediate gradation, a luminance of the second display data after conversion is lower than that of the first display data after the conversion.
(2) In the display device as in (1), the driver outputs a first image voltage corresponding to the converted first display data to the plural sub-pixels in a first frame interval of the two consecutive frame intervals, and outputs a second image voltage corresponding to the converted second display data to the plural sub-pixels in a second frame interval of the two consecutive frame intervals.
(3) In the display device as in (1) or (2), a frame memory which stores the display data in a present frame, and display data in a frame prior to the present frame is further provided. The overdrive circuit determines a correction amount with respect to the overdrive process to the first display data based on a difference between the display data in the present frame and the display data in the frame prior to the present frame.
(4) In the display device as in any one of (3), a circuit which outputs an accord signal when the display data in the present frame and the display data in the frame prior to the present frame stored in the frame memory accord with each other is further provided. The accord signal is used instead of the frame distinction signal.
(5) In the display device as in any one of (1) to (4), the sub-pixels display two gradations in the two consecutive frame intervals to display a single gradation demanded by the external system. When the gradation demanded by the external system is contained in a low gradation side in an intermediate gradation between a maximum gradation and a minimum gradation, one of the two gradations in the two consecutive frame intervals is the minimum gradation and the other of the two gradations in the two consecutive frame intervals changes in accordance with the gradation demanded by the external system. When the gradation demanded by the external system is contained in a high gradation side in the intermediate gradation, one of the two gradations in the two consecutive frame intervals changes in accordance with the gradation demanded by the external system, and the other one of the two gradations in the two consecutive frame intervals is the maximum gradation.
(6) In the display device as in (5), when the gradation demanded by the external system is the maximum gradation, the two gradations in the two consecutive frame intervals are the maximum gradations.
(7) In the display device as in (5), in a boundary of the gradation demanded by the external system between the low gradation side and the high gradation side, one of the two gradations in the two consecutive frame intervals is set to the minimum gradations, and the other of the two gradations is set to the maximum gradation.

The effect derived from the present invention to be disclosed herein will be briefly explained.

The display device according to the present invention receives the external input of the identical display data twice to improve the video performance by distinguishing the order of the input of the display data.

### BRIEF DESCRIPTION OF THE DRAWINGS

FIG. 1 is a block diagram schematically showing the structure of a liquid crystal display module according to an embodiment of the present invention;

FIG. 2 is a block diagram schematically showing the structure of a display data conversion circuit shown in FIG. 1;

FIG. 3I to FIG. 3K represent the FBI drive method for the liquid crystal display module according to the embodiment of the present invention;

FIG. 4 is a view representing features of the conversion of the input display data into those for the bright frame and the dark frame;

FIG. 5 shows an example of another look-up table which stores the FBI set values shown in FIG. 2;

FIG. 6A to FIG. 6D represent the conventional FBI drive method; and

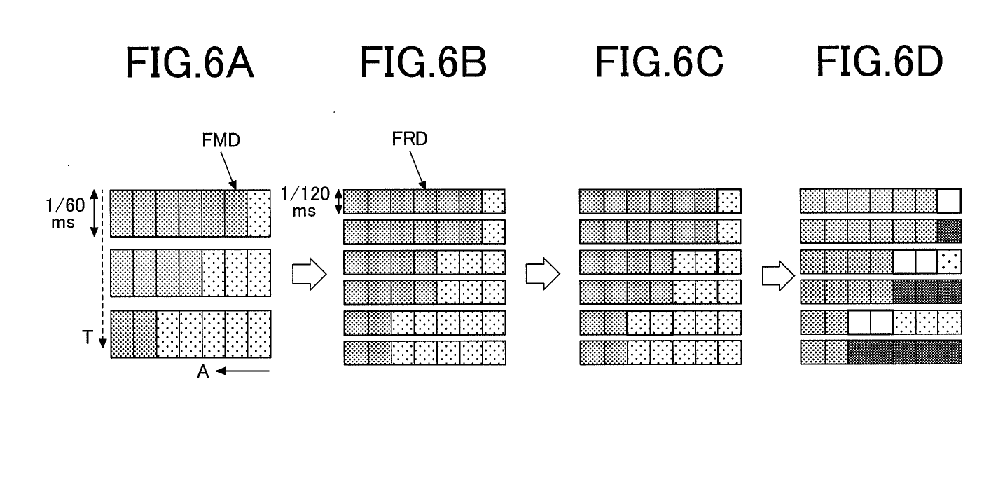

FIG. 7E to FIG. 7H represent the FBI drive method performed when the frame distinction signal (FJ-Rync) has not been input.

### DETAILED DESCRIPTION OF THE INVENTION

An embodiment of the present invention will be described referring to the drawings.

In the drawings with respect to the embodiment, the component having the same function will be designated with the same code, and the explanation thereof, thus will not be repeated.

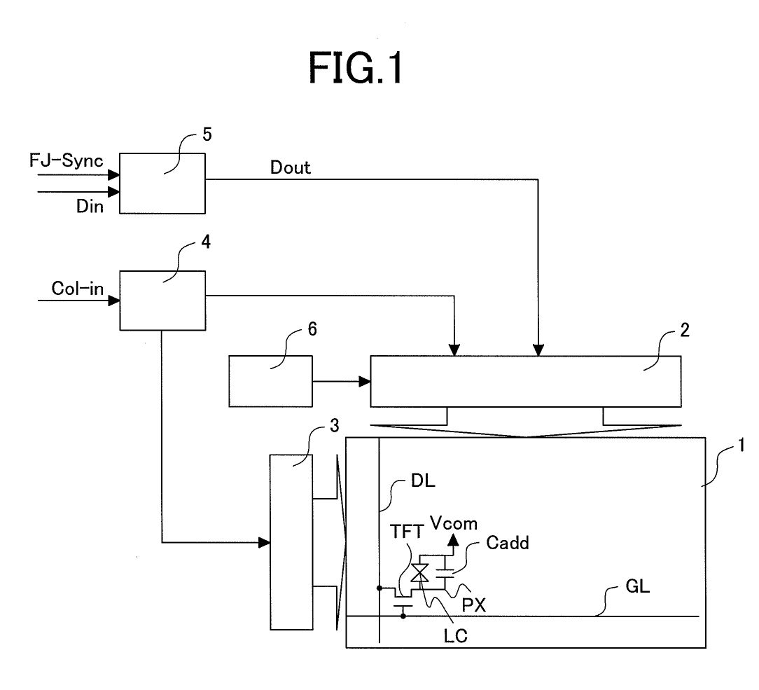

FIG. 1 is a block diagram schematically showing a structure of a liquid crystal display module according to an embodiment of the present invention.

The liquid crystal display module includes a liquid crystal display panel 1, a drain driver 2, a gate driver 3, a timing generation circuit 4, a display data conversion circuit 5, and a gradation voltage generation circuit 6.

The drain driver 2 and the gate driver 3 are disposed around the liquid crystal display panel 1. The gate driver 3 is formed of plural gate drivers IC arranged on one side of the liquid crystal display panel 1. The drain driver 2 is formed of plural drain drivers IC arranged on the other side of the liquid crystal display panel 1.

The timing generation circuit 4 drives the gate driver 3 and the drain driver 2 based on a vertical sync signal (Vsync) for specifying the single frame interval (for displaying the single signal), a horizontal sync signal for specifying the single horizontal scan interval (for displaying the single line), a display timing signal (DISP) for specifying the effective interval for the display data, and the reference clock signal (DCLK) in synchronization with the display data, which are input from the external system (for example, TV unit, PC, and the portable phone).

FIG. 1 shows an image line (drain line or source line) DL, a scan line (gate line) GL, a pixel electrode PX for the respective colors (red, green and blue), an opposite electrode (common electrode) CT, a liquid crystal capacity LC as being equivalent to the liquid crystal layer, and a retention capacity Cadd formed between the opposite electrode (CT) and the pixel electrode (PX).

In the liquid crystal display panel 1, drain electrodes of a thin film transistor (TFT) of the respective sub-pixels arranged in the column direction are connected to the image lines (DL). The respective image lines (DL) are connected to the drain driver 2 for supplying the image voltage corresponding to the display data to the sub-pixels arranged in the column direction.

The gate electrodes of the thin film transistor (TFT) for the respective sub-pixels arranged in the row direction are connected to the scan lines (GL) which are connected to the gate driver 3 for supplying the scan voltage (positive or negative bias voltage) to the gate of the thin film transistor (TFT) for the single horizontal scan interval.

The gate driver 3 supplies the scan voltage to the scan line (GL) under the control of the timing generation circuit 4, and the drain driver 2 supplies the image voltage (the gradation voltage generated in the gradation voltage generation circuit 6 corresponding to the display data) to the image line (DL) under the control of the timing generation circuit 4 to display the image.

When the image is displayed on the liquid crystal panel 1, the gate driver 3 supplies the selection scan voltage to the scan lines (GL) sequentially downward (or upward) to select the scan line (GL). Meanwhile, the drain driver 2 supplies the image voltage corresponding to the display data to the image line (DL) during the period for selecting the predetermined scan line (GL) so as to be applied to the pixel electrode (PX).

The voltage supplied to the image line (DL) is applied to the pixel electrode (PX) via the thin film transistor (TFT), and the retention volume (Cadd) and the liquid crystal capacity (LC) are charged with the electric charge to display the image by controlling the liquid crystal molecules.

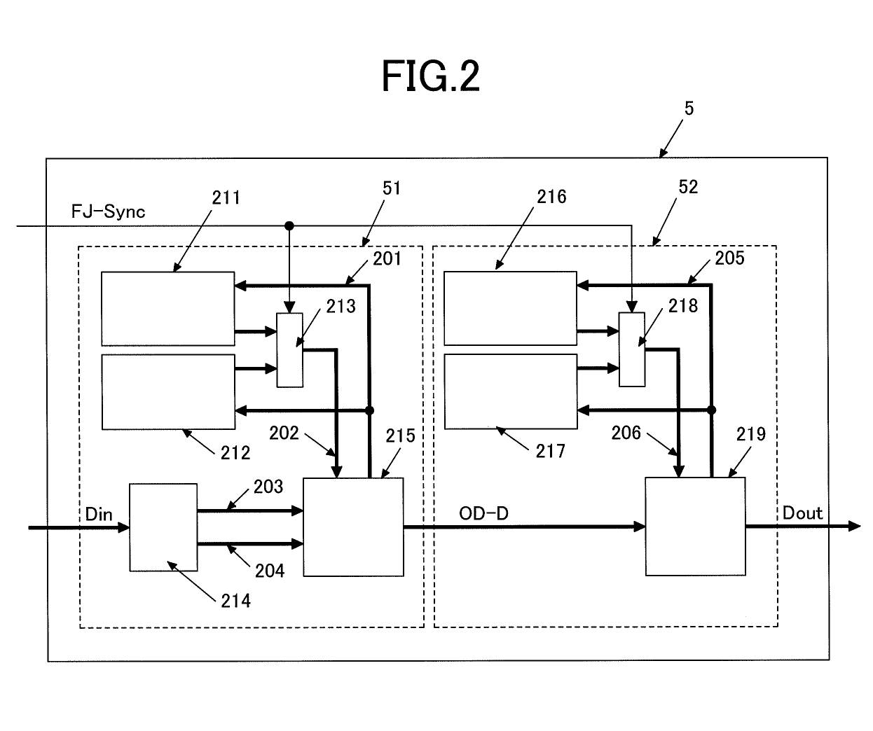

FIG. 2 is a block diagram schematically showing the structure of the display data conversion circuit 5 shown in FIG. 1. Referring to FIG. 2, an overdrive process circuit 51 and an FBI process circuit are provided.

The overdrive process circuit 51 includes a look-up table 211 which stores the overdrive correction amount for the bright frame, a look-up table 212 which stores the overdrive correction amount for the dark frame, a selector 213, a memory 214, and a calculation circuit 215. The bright frame and the dark frame will be described later.

In the embodiment, the identical display data are externally input twice for each frame at 120 Hz. The display data externally input for each frame at 120 Hz are stored in the memory 214 in series. Referring to FIG. 2, a frame distinction signal (FJ-Rync) for distinguishing the first display data from the second display data is externally input in the embodiment.

The display data 203 in the frame prior to the present frame read from the memory 214, and the display data 204 in the present frame are input to the calculation circuit 215 such that those data are compared with each other to generate a readout address 201. The overdrive correction amount is read from the look-up tables 211 and 212, respectively.

Based on the selector 213 controlled in accordance with the frame distinction signal (FJ-Rync), one of the overdrive correction amounts read from the look-up tables 211 and 212 is selected, and the selected value is input to the calculation circuit 215 as the overdrive correction amount 202. The calculation circuit 215 adds or subtracts the overdrive correction amount 202 to or from the display data 204 to subject the display data 204 in the present frame to the overdrive process. Actually, the bright frame is only subjected to the overdrive process, and therefore, the correction amount inside the look-up table 212 is set to 0.

The FBI process circuit 52 is formed of a look-up table 216 which stores the FBI set values for the bright frame, a look-up table 217 which stores the FBI set values for the dark frame, a selector 218, and a calculation circuit 219.

As described above, in the embodiment, the identical display data are externally input twice for each frame at 120 Hz. Assuming that the display data to be input first is referred to as the first display data, and the display data to be input the next is referred to as the second display data, the first display data are set for the bright frame, and the second display data are set for the dark frame.

The display data output from the calculation circuit 215 are input to the calculation circuit 219. The calculation circuit 219 reads the FBI set value 206 corresponding to the display data output from the calculation circuit 215 from the look-up tables 216 and 217, respectively. One of the FBI set values read from the look-up tables 216 and 217 is selected by the selector 218 so as to be input to the calculation circuit 219, and is further converted into those for the bright frame or the dark frame.

The selector 218 is controlled by the frame distinction signal (FJ-Rync) to allow the first and the second display data to be converted into those for the bright frame and the dark frame, respectively.

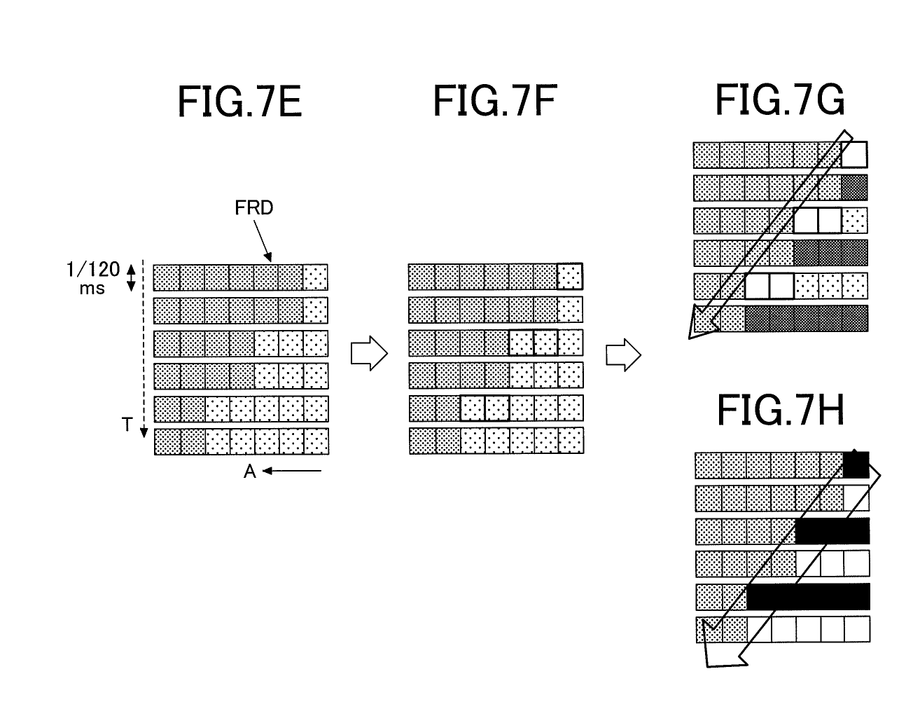

FIG. 7E to FIG. 7H represent the FBI drive method when the frame distinction signal (FJ-Rync) is not input in the case where the gray subject moves to the arrow direction A. Referring to FIG. 7E to FIG. 7H, the code RFD denotes the luminance of the sub-pixel on the single display line in the single frame, and the arrow with dashed line denotes the time passage.

Referring to FIG. 7E, the liquid crystal display module receives the identical display data twice for each frame interval at 120 Hz twice as high as 60 Hz. As described above, the display data to be input first, that is, the first display data are set for the bright frame, and the display data to be input next, that is, the second display data are set for the dark frame.

Referring to FIG. 7F, the first display data are subjected to the overdrive (OD) process. Referring to FIG. 7E to FIG. 7H, the sub-pixel corresponding to the display data subjected to the overdrive process is shown in the bold frame. Only the first display data for the bright frame are subjected to the overdrive (OD) process.

Then the FBI process is performed. As the first and the second display data cannot be distinguished, two drive methods are performed, that is, the conversion of the first and the second display data into those for the bright and the dark frames, respectively as shown in FIG. 7G, and the conversion of the first and the second display data into those for the dark and the bright frames, respectively as shown in FIG. 7H.

In the case shown in FIG. 7G, the blur width is narrow and the motion performance is in good condition. Meanwhile in the case shown in FIG. 7H, the blur width is wide, and the motion performance is deteriorated.

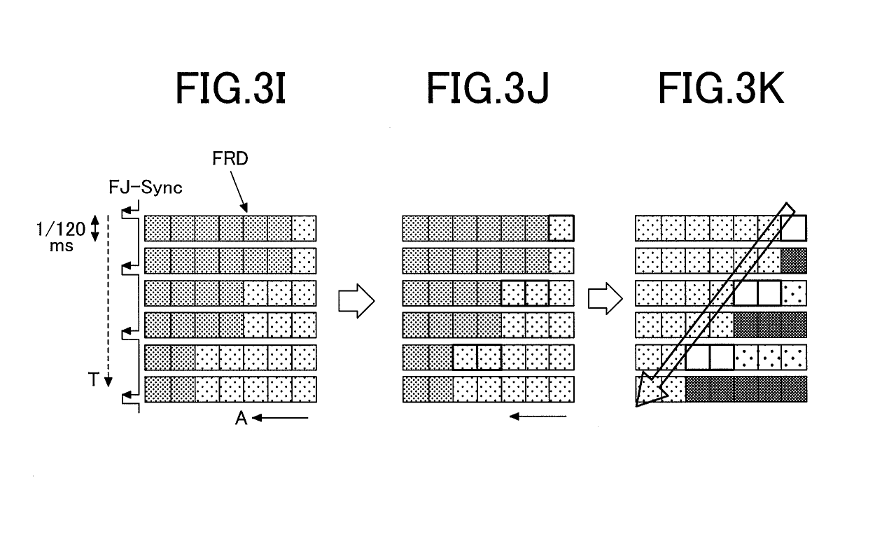

FIG. 3I to FIG. 3K represent the FBI drive method according to the embodiment in the state where the gray subject moves in the arrow A direction. Referring to FIG. 3I to FIG. 3K, the code FRD denotes the luminance of the sub-pixel on the single display line in the single field, and the arrow with the dashed line denotes the time passage.

In the embodiment, the liquid crystal display module receives the input of the identical display data twice for each frame interval at 120 Hz twice as high as 60 Hz as shown in FIG. 3I. Referring to FIG. 3J, the first display data are subjected to the overdrive (OD) process. As shown in FIG. 3I to FIG. 3K, the sub-pixel corresponding to the display data subjected to the overdrive process is shown in the bold frame. Only the first display data are subjected to the overdrive (OD) process.

The FBI process is then performed. In the embodiment, the frame distinction signal (FJ-Rync) is input. The display data to be input first after detection of the rise in the frame distinction signal (FJ-Rync) is set as the first display data. This ensures to convert the first and the second display data into those for the bright and the dark frames, respectively.

In the embodiment, it is determined whether the display data 203 in the frame prior to the present frame stored in the memory 214 accord with the display data 204 in the present frame. When they accord with each other, an accord signal is output. It is possible to use the accord signal instead of the frame distinction signal (FJ-Rync).

The FBI process in the embodiment will be briefly described.

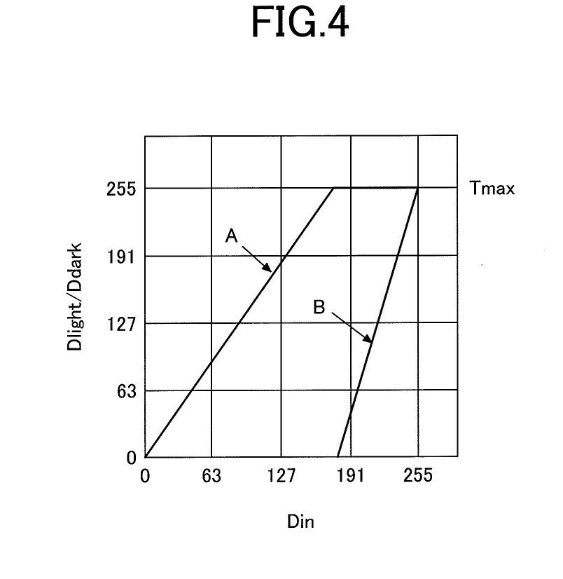

FIG. 4 is a graph having the input display data (Din) as x-axis, and the display data for the bright frame/dark frame (Dlight/Ddark) as y-axis for representing features of the conversion of the input display data into those for the bright/dark frames.

In the embodiment, the frame for displaying the image based on the display data with the conversion feature as shown by A is set as the bright frame. The frame for displaying the image based on the display data with the conversion feature as shown by B is set as the dark frame. Generally, the liquid crystal display panel has the static luminance T changed in accordance with the liquid crystal application voltage V. The static luminance T at a minimum is set to Tmin, and the static luminance T at a maximum is set to Tmax.

The conversion algorithm in the embodiment realizes the visual luminance corresponding to the input display data by combining the bright and dark frames in the condition where the dark frame obtains the dynamic luminance which becomes Tmin on the liquid crystal display panel, and the static luminance which makes the input display data the brightest in 256 gradations is equal to the Tmax.

The motion blur may be reduced by reducing the dynamic luminance of the dark frame, and enlarging the range where the dynamic luminance of the dark frame is low. Preferably, the dark frame is set as Tmin. However, the luminance slightly higher than the Tmin may be employed. The dynamic luminance of the dark frame is set to Tmin in the range from 0 gradation to that of the input display data corresponding to the visual luminance obtained by setting the dynamic luminance of the bright frame to Tmax, and setting the dynamic luminance of the dark frame to Tmix. However, the gradation slightly lower than that of the input display data corresponding to the visual luminance obtained by setting the dynamic luminance of the bright frame to Tmax, and setting the dynamic luminance of the dark frame to Tmix may also be employed.

The dynamic luminance of the bright frame is set to Tmax in the range from the gradation of the input display data corresponding to the visual luminance obtained by setting the dynamic luminance of the dark frame to Tmax, and setting the dynamic luminance of the dark frame to Tmin to the 256 gradation. The gradation slightly lower than that of the input display data corresponding to the visual luminance obtained by setting the dynamic luminance of the bright frame to Tmax, and the dynamic luminance of the dark frame to Tmin may also be employed.

Preferably, on the display, the luminance difference between the respective gradations is at substantially equal interval when viewed by the observer. In case of 256-gradation, the display data D for driving the liquid crystal and the static luminance T is correlated to satisfy the gamma curve as expressed by the following equation (1).

### [Equation 1]

(static luminance T)=(liquid crystal drive data D/255)̂γ (1)

As γ=2.2 is generally used, the explanation will be made using such value.

Assuming that the rise-up time and drop time of the liquid crystal display panel 1 are set to Tr and Tf are 0, the display luminance may be approximated as expressed by the following equation (2):

### [Equation 2]

display luminance=(static luminance T of the bright frame/)2+(static luminance T in the dark frame)/2 (2)

Assuming that the input display data are set to Din, the display data in the bright frame are set to Dlight, and the display data in the dark frame are set to Ddark, the following equation (3) may be derived from the aforementioned equations (1) and (2) having the γ set to 2.2, thus providing the feature shown by the solid line of FIG. 4.

$$Dlight = \{ \begin{matrix} 2 \hat{} ( 1 / 2.2 ) * Din & where \begin{matrix}2 \hat{} ( 1 / 2.2 ) * \\ Din < 255\end{matrix} \\ 255 & where \begin{matrix}2 \hat{} ( 1 / 2.2 ) * \\ Din ≧ 255\end{matrix}\end{matrix} \\ Ddark = \{ \begin{matrix} 0 & where \begin{matrix}2 \hat{} ( 1 / 2.2 ) * \\ Din < 255\end{matrix} \\ 255 * \{ \begin{matrix}2 * ( Din / 255 ) \hat{} \\ 2.2 - 1\end{matrix} \} \hat{} ( 1 / 2.2 ) & where \begin{matrix}2 \hat{} ( 1 / 2.2 ) * \\ Din ≧ 255\end{matrix}\end{matrix} \qquad [ Equation 3 ]$$

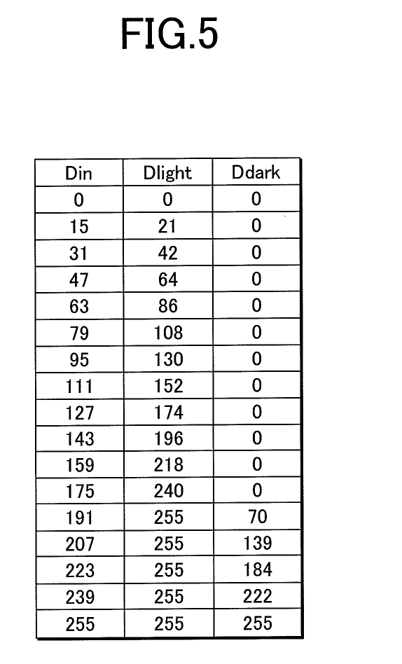

The look-up tables 216 and 217 do not have to contain the table values corresponding to all the input display data (Din) but may be formed in the arbitrary form so long as the linearity between the gradations is sufficiently achieved. For example, the table for each 16-gradation is prepared as shown in FIG. 5, and the conversion display data with respect to the intermediate gradations may be generated through the interpolation such as the linear interpolation. This makes it possible to reduce the size of the conversion table.

In the embodiment, the present invention is applied to the liquid crystal display module. However, it may be applied to the hold type display device such as the organic EL (Electro Luminescence) display and the LCOS (Liquid Crystal On Silicon) display.

The present invention has been described based on the embodiment. It is to be understood that the present invention is not limited to the aforementioned structure but may be changed and modified into various forms without departing from scope of the invention.

What is claimed is:

1. A display device comprising:
a display panel including plural sub-pixels;
a first conversion circuit and a second conversion circuit each for converting display data in an intermediate gradation input from an external system into different values;
a signal generation circuit that generates a control signal for driving the display panel based on a signal input from the external system; and
a driver for outputting an image voltage corresponding to the display data to the plural sub-pixels, the display device receiving two identical data of first and second display data sequentially from the external system in a two consecutive frame intervals,
the driver further including an overdrive circuit for subjecting the first display data to an overdrive process,
wherein: the first conversion circuit converts the first display data subjected to the overdrive process in the overdrive circuit based on a frame distinction signal input from the external system;
the second conversion circuit converts the second display data based on the frame distinction signal; and
when the display data input from the external system is in the intermediate gradation, a luminance of the second display data after conversion is lower than that of the first display data after the conversion.

2. The display device according to claim 1, wherein the driver outputs a first image voltage corresponding to the converted first display data to the plural sub-pixels in a first frame interval of the two consecutive frame intervals, and outputs a second image voltage corresponding to the converted second display data to the plural sub-pixels in a second frame interval of the two consecutive frame intervals.

3. The display device according to claim 1, further comprising a frame memory which stores the display data in a present frame, and display data in a frame prior to the present frame,
wherein the overdrive circuit determines a correction amount with respect to the overdrive process to the first display data based on a difference between the display data in the present frame and the display data in the frame prior to the present frame.

4. The display device according to claim 2, further comprising a frame memory which stores the display data in a present frame, and display data in a frame prior to the present frame,
wherein the overdrive circuit determines a correction amount with respect to the overdrive process to the first display data based on a difference between the display data in the present frame and the display data in the frame prior to the present frame.

5. The display device according to claim 3, further comprising a circuit which outputs an accord signal when the display data in the present frame and the display data in the frame prior to the present frame stored in the frame memory accord with each other,
wherein the accord signal is used instead of the frame distinction signal.

6. The display device according to claim 4, further comprising a circuit which outputs an accord signal when the display data in the present frame and the display data in the frame prior to the present frame stored in the frame memory accord with each other,
wherein the accord signal is used instead of the frame distinction signal.

7. The display device according to claim 1,
wherein: the sub-pixels display two gradations in the two consecutive frame intervals to display a single gradation demanded by the external system;
when the gradation demanded by the external system is contained in a low gradation side in an intermediate gradation between a maximum gradation and a minimum gradation, one of the two gradations in the two consecutive frame intervals is the minimum gradation and the other of the two gradations in the two consecutive frame intervals changes in accordance with the gradation demanded by the external system; and
when the gradation demanded by the external system is contained in a high gradation side in the intermediate gradation, one of the two gradations in the two consecutive frame intervals changes in accordance with the gradation demanded by the external system, and the other one of the two gradations in the two consecutive frame intervals is the maximum gradation.

8. The display device according to claim 2,
wherein: the sub-pixels display two gradations in the two consecutive frame intervals to display a single gradation demanded by the external system;
when the gradation demanded by the external system is contained in a low gradation side in an intermediate gradation between a maximum gradation and a minimum gradation, one of the two gradations in the two consecutive frame intervals is the minimum gradation and the other of the two gradations in the two consecutive frame intervals changes in accordance with the gradation demanded by the external system; and
when the gradation demanded by the external system is contained in a high gradation side in the intermediate gradation, one of the two gradations in the two consecutive frame intervals changes in accordance with the gradation demanded by the external system, and the other one of the two gradations in the two consecutive frame intervals is the maximum gradation.

9. The display device according to claim 7, wherein when the gradation demanded by the external system is the maximum gradation, the two gradations in the two consecutive frame intervals are the maximum gradations.

10. The display device according to claim 8, wherein when the gradation demanded by the external system is the maximum gradation, the two gradations in the two consecutive frame intervals are the maximum gradations.

11. The display device according to claim 7, wherein in a boundary of the gradation demanded by the external system between the low gradation side and the high gradation side, one of the two gradations in the two consecutive frame intervals is set to the minimum gradations, and the other of the two gradations is set to the maximum gradation.

12. The display device according to claim 8, wherein when the gradation demanded by the external system is the maximum gradation, the two gradations in the two consecutive frame intervals are set to the maximum gradations.
